(19) United States
(12) Patent Application Publication
(10) Pub. No.: US 2005/0276236 A1
(43) Pub. Date: Dec. 15, 2005

(54) Separation radio information transmission system

(75) Inventor: Yu Chen, Taipei City (TW)

Correspondence Address: TROXELL LAW OFFICE PLLC, SUITE 1404, 5205 LEESBURG PIKE, FALLS CHURCH, VA, 22041, US

(73) Assignee: Uniwill Computer Corp.

(21) Appl. No.: 10/958,363

(22) Filed: Oct. 6, 2004

(30) Foreign Application Priority Data
Jun. 11, 2004 (TW) 093209299

(51) Int. Cl. H04L 1/00; H04B 7/00

(52) U.S. Cl. 370/310

(57) ABSTRACT

A separation radio information transmission system comprising a host and one or multiple remote terminal; the host being integrated with microprocessor, high-capacity storage medium, memory, wireless transmission modulus; the remote terminal may being a MP3 player or a digital camera integrated with wireless transmission modulus; both of the host and the remote terminal each allowing standing alone information transmission; when coupled with the wireless transmission modulus, the remote terminal may download video or audio data from the storage medium of the host, and data retrieved by the remote terminal may be stored in the storage medium; and the host may be concealed to avoid confining the working space and operation of the user.

### BACKGROUND OF THE INVENTION

(a) Field of the Invention

The present invention is related to an information technology (IT) devices integration technology, and more particularly, to one separation radio information transmission system that is provided with interoperability while allowing standing alone control and operation.

(b) Description of the Prior Art

Mobile information devices including notebook computer, tablet PC, and personal digital assistance (PDA) operate on DC power from batteries, making them portable. However, operation and process capabilities, and data storage capacity of mobile information devices must be comparable with those of desktops. NB and tablet PC are prevented from longtime hand-held use, or being made pocket size.

For easier portability and operation, data storage capacity and operation capability of hand-held information devices, such as MP3 player or digital camera, have to be compromised, thus to fail the practical needs of the user since the size and weight considerations dominate the design. As a result, the user has to always repeat deleting and updating the existing data to exchange for more space of storage for additional music and/or video data.

### SUMMARY OF THE INVENTION

The primary purpose of the present invention is to provide a separation radio information transmission system comprised of a host and one or multiple remote terminal. Wherein, the host is integrated with microprocessor, high capacity storage medium, memory, wireless transmission modulus, and power supply modulus. The remote terminal is integrated with microprocessor, digital/analog converter, memory, wireless transmission modulus, output port, power supply modulus and related keys of MP3 player, or integrated with microprocessor, photo-sensor, memory, wireless transmission modulus, power supply modulus, and related operation keys of digital camera.

Accordingly, a standing alone host, an MP3 player and a digital camera are combined. Though the linkage of the wireless transmission modulus, the data in music format in the high capacity storage medium of the host can be downloaded to the MP3 player for broadcasting; or alternatively, the high capacity storage medium of the host operates as the video data storage space for the digital camera to significantly expand the data storage capacity of the remote terminal.

### BRIEF DESCRIPTION OF THE DRAWINGS

FIG. 1 is a view showing a configuration of a first preferred embodiment of the present invention.

FIG. 2 is a view showing a flow chart of the first preferred embodiment of the present invention.

FIG. 3 is a view showing a configuration of a second preferred embodiment of the present invention.

FIG. 4 is a view showing a flow chart of the second preferred embodiment of the present invention.

FIG. 5 is a view showing a configuration of a third preferred embodiment of the present invention.

FIG. 6 is a view showing a flow chart of the third preferred embodiment of the present invention.

### DETAILED DESCRIPTION OF THE PREFERRED EMBODIMENTS

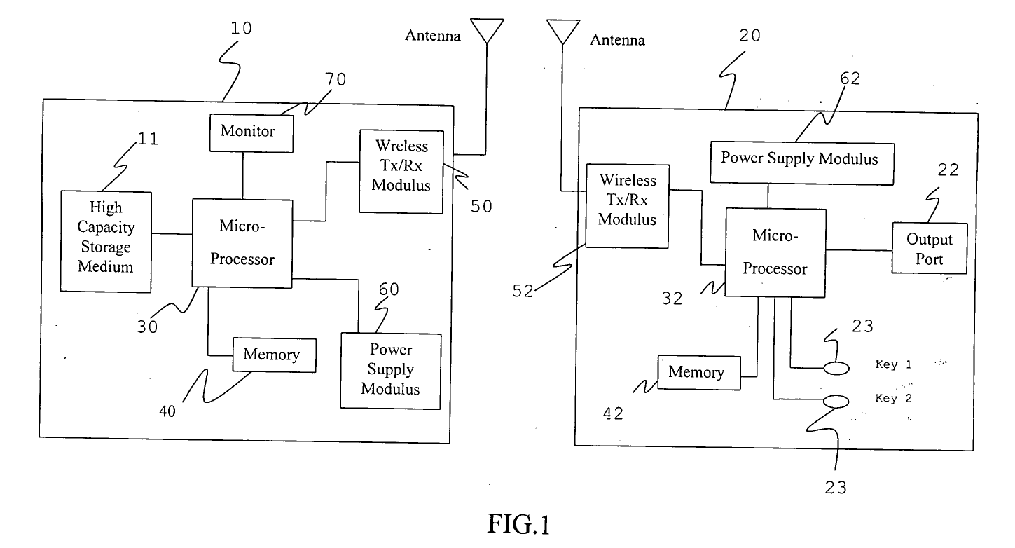

Referring to FIG. 1 for a configuration of a first preferred embodiment of the present invention, a separation radio information transmission system comprising a host 10 and a remote terminal 20. The host 10 includes a microprocessor 30, a high capacity storage medium 11 (e.g., hard disk or CD-ROM drive), a memory 40, a wireless transmission modulus 50, a power supply modulus 60, and a monitor 70 combined into a standing alone portable electronic system (e.g., a tablet PC, notebook computer or PDA). Wherein, the power supply modulus 60 of the host 10 relates to a cabled and/or battery-based modulus.

The remote terminal 20 integrated with a microprocessor 32, a memory 42, a wireless transmission modulus 52, an output port 22, a battery-based power supply modulus 62, and related keys 23 combined into a standing alone MP3 player.

Accordingly, in the separation information transmission system, both of the host 10 and the remote terminal 20 are each capable of independent operation. Furthermore, through the linkage to the wireless transmission modulus 50 (e.g., Bluetooth wireless transmission modulus), the remote terminal 20 and the host 10 are coupled to each other for operation.

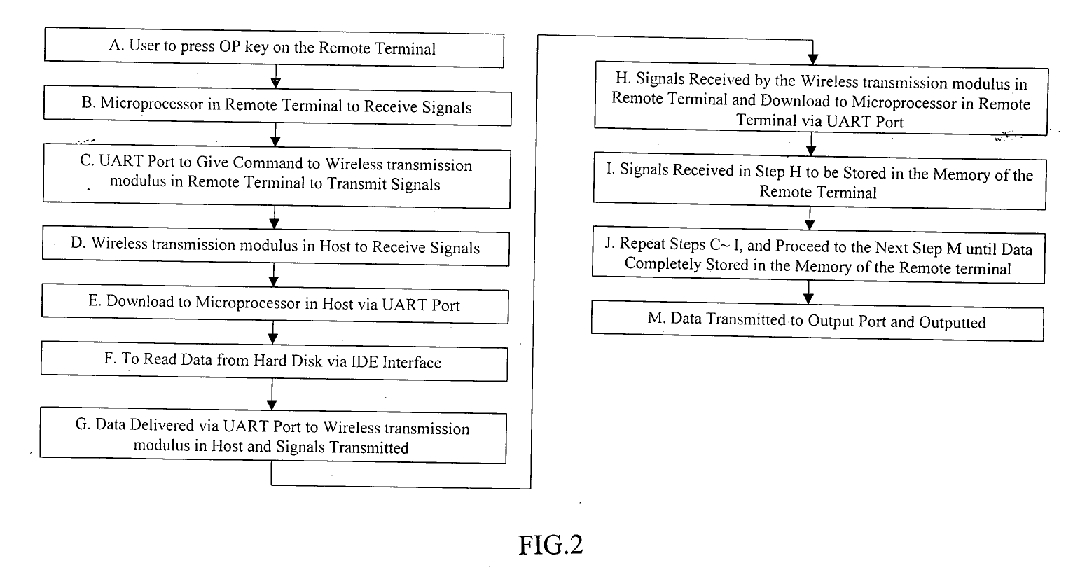

As illustrated in FIG. 2 for a flow chart of the operation of the first preferred embodiment of the present invention, once a user presses an operation key 23 at the remote terminal 20, signals are received by the microprocessor 32 of the remote terminal 20, a command is transmitted from the wireless transmission modulus 52 to the wireless transmission modulus 50 of the host 10 via a universal asynchronous receiver/transmitter (UART) interface. Through the UART interface, the command is then transmitted to the microprocessor 30 of the host 10 to read the data in the high capacity storage medium 11 via data bus interface (not illustrated); and data retrieved are transmitted from the wireless transmission modulus 50 to the remoter terminal 20 through the route of the data bus interface and the UART interface. Once received by the wireless transmission modulus 52 in the remote terminal 20, data are transmitted to the microprocessor 32 in the remote terminal 20 via the UART interface and stored in the memory 42 (as a buffer) to be read out until the completion of downloading the data transmitted form the host 10, and transmitted to the respective peripheral for output through the output port 22.

On the contrary, the data file in the remote terminal 20 are transmitted to the high capacity storage medium 11 of the host in the similar route to utilize the data storage space offered by the high capacity storage medium 11.

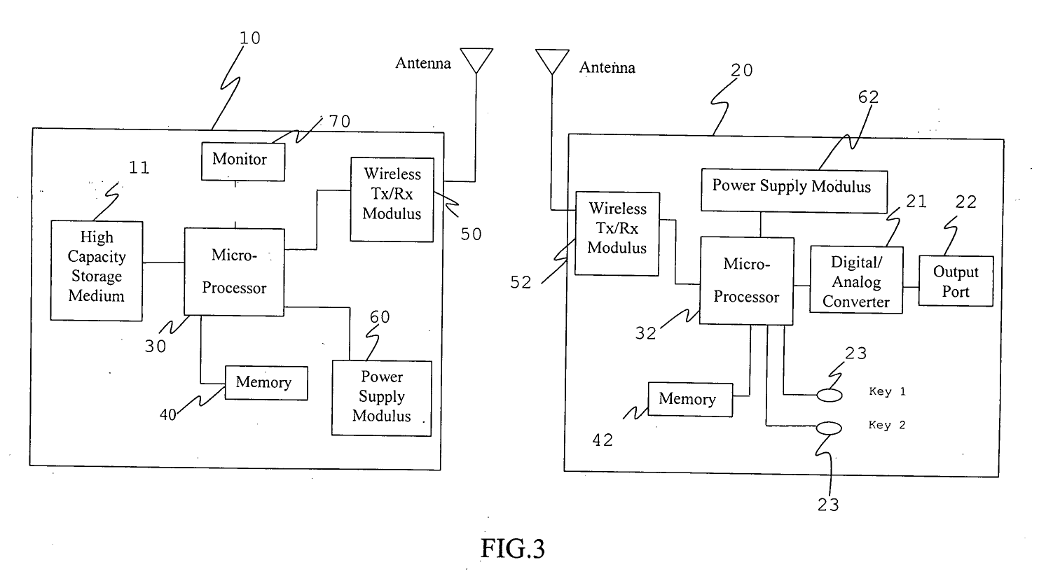

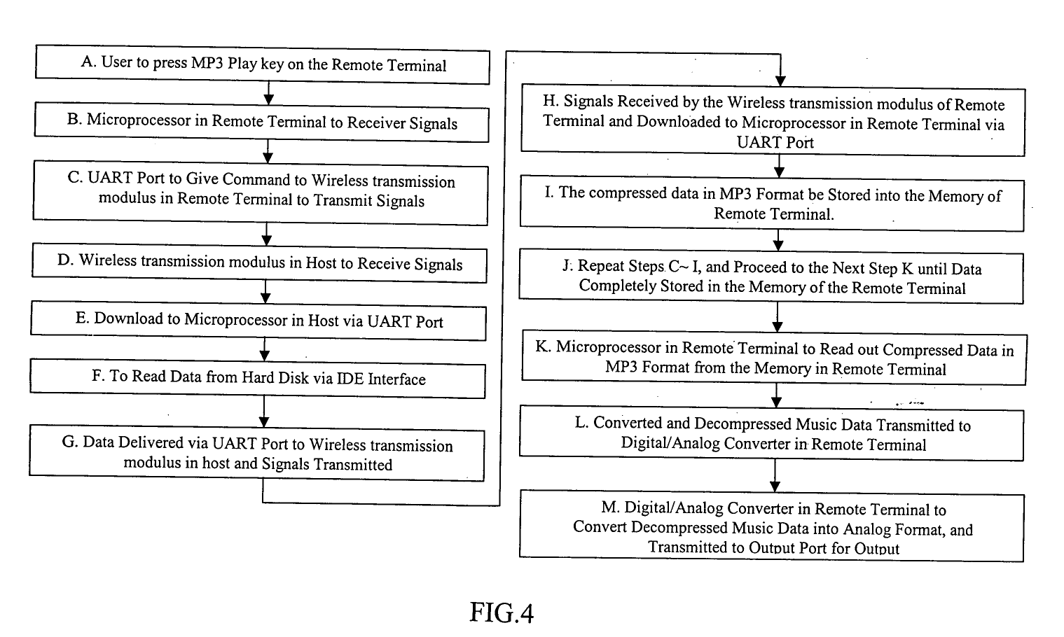

Now referring to FIGS. 3 and 4 respectively of views showing a configuration and a flow chart of a second preferred embodiment of the present invention; wherein, upon receiving signals once the operation key 23 at the remote terminal 20 is pressed to play data in music format, the microprocessor 32 in the remote terminal 20 gives a command to be transmitted from the wireless transmission modulus 52 via the UART interface to the host 10. After receiving the signals, the wireless transmission modulus 50 of the host 10 transmits the command via the UART interface to the microprocessor 30 of the host 10, and further to read the data (e.g., MP3 compressed data) in the high capacity storage medium 11 via the data bus interface. Data read out are then transmitted to the remote terminal 20 by the wireless transmission modulus 50 to be picked up by the wireless transmission modulus 52 of the remote terminal 20 and transmitted to the microprocessor 32 in the remote terminal 20 via the UART interface. The data are registered in the memory 42. Upon the entire MP3 compressed data are fully downloaded (e.g., a complete song) and stored in the memory 42, the entire MP3 compressed data are read out from the memory 40 and decompressed to convert the sound effects into analog sound effects by means of the digital/analog converter 21 to be transmitted through the output port 22 to peripheral (e.g. an earpiece or speaker) connected to the output port 22 for broadcasting.

By the operation mode described above, the user may take advantage of the storage space available in the high capacity storage medium 11 of the host 10 to store MP3 music, thus to significantly increase the capacity of playing the data in music format at the remote terminal 20. As a result, function and utility of the remote terminal 20 are significantly improved. Wherein, the host 10 for being concealed in a proper accommodation environment will not affect the space and operation of the user.

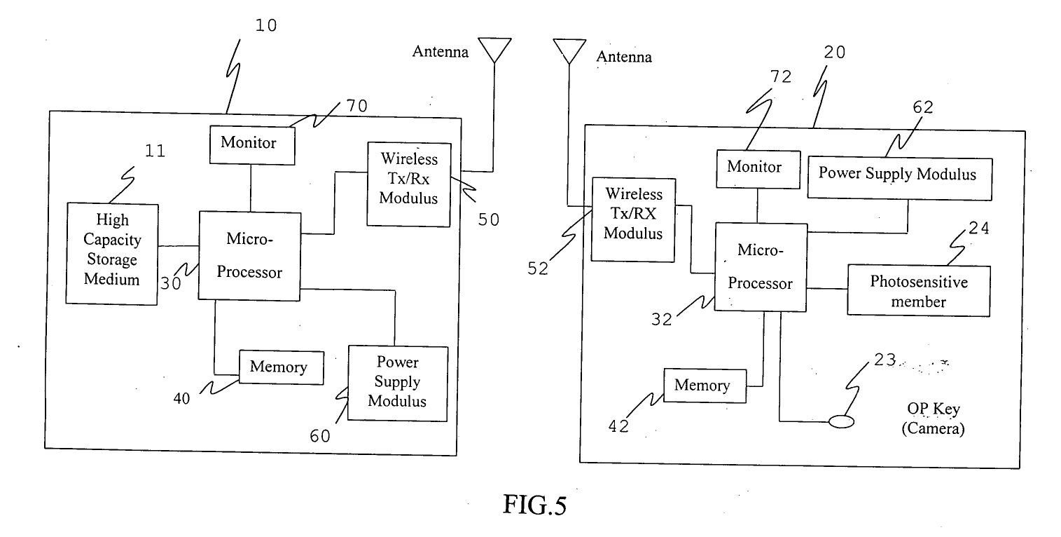

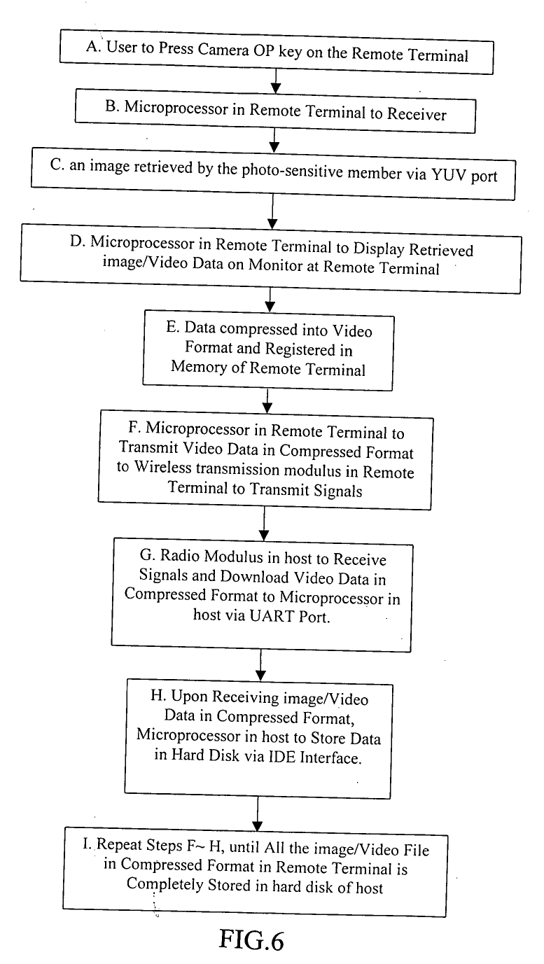

As illustrated in FIGS. 5 and 6 respectively showing a configuration and flow chart of a third preferred embodiment of the present invention; wherein, the remote terminal 20 is integrated with the microprocessor 32, a photo-sensitive member 24 (e.g. a CMOS, or CCD), the memory 42, the wireless transmission modulus 52, the power supply modulus 62, the operation key 23, and a monitor 72 to function as a standing alone digital camera. The remote terminal 20 (i.e. the digital camera) of the third preferred embodiment is able to achieve the interoperating transmission with the host 10 by means of the radio transmission moduli 50 and 52.

As illustrated in FIGS. 5 and 6, when the functional key 23 of camera is pressed at the remote terminal 20 by the user, the microprocessor 32 of the remote terminal 20 receive the signals to present on the monitor 72 of the remote terminal 20 and the image retrieved by the photo-sensitive member 24 through a YUV interface (YUV relates to a type of color space, wherein, Y represents Luminance; U, Hue, and V, saturation). The images data are compressed into various types of formats (e.g. JEPG file) and are registered in the memory 42 of the remote terminal 20. With the UART interface, the data are transmitted from the wireless transmission modulus 52 to the host 10, where data signals are received by the wireless transmission modulus 50 and the command is transmitted to the microprocessor 30 of the host 10 via the UART interface for the data to be registered in the high capacity storage medium 11 through the data bus interface. The user may repeat registering the images retrieved from the remote terminal 20 into the high capacity storage medium 11 in the host through the data bus interface to significantly upgrade the image storage space of the remote terminal 20, thus to improve the function and utility of the remote terminal 20.

Furthermore, various data transmission ports (not illustrated) may be respectively integrated to the host 10 and the remote terminal 20 of the present invention. For example, when integrated with a universal Serial Bus (USB), communication/transmission of command and data between the host 10 and the remote terminal 20 are feasible through a transmission line.

The present invention for providing a system comprised of a host and a remote terminal with both capable of standing alone operation and are coupled to each other by radio transmission effectively upgrades the data storage space, thus the function and utility of the remote terminal. Therefore, this application for a utility patent is duly filed. However, it is to be noted that those preferred embodiments disclosed in the specification and the accompanying drawings are in no way limiting the present invention. Therefore, any construction, installation, or characteristics that is same or similar to that of the present invention should fall within the scope of the purposes and claims of the present invention.

1. A separation radio information transmission system comprised of a host and a remote terminal; the host being integrated with a microprocessor, a high capacity storage medium, a memory, a wireless transmission modulus and a power supply modulus;
and the remote terminal being integrated with a microprocessor, digital/analogy converter, a memory, a wireless transmission modulus, an output port, a power supply modulus and related operation keys; both of the host and the remote terminal being capable of standing alone control and operation as a radio information transmission device; both being coupled to each other by means of the wireless transmission modulus; and the high capacity storage medium in the host providing high capacity data of sound effects to the remote terminal for broadcasting.

2. The separation radio information transmission system of claim 1, wherein, the host is further integrated with a monitor.

3. The separation radio information transmission system of claim 1, wherein, the remote terminal is further integrated with a monitor.

4. The separation radio information transmission system of claim 1, wherein, a data transmission port is provided to the host and the remote terminal.

5. The separation radio information transmission system of claim 1, wherein, the wireless transmission modulus relates to a Bluetooth wireless transmission modulus.

6. The separation radio information transmission system of claim 1, wherein, the power supply modulus operates on battery power.

7. The separation radio information transmission system of claim 1, wherein, the host relates to a portable electronic device including a notebook computer, a tablet PC or a PDA.

8. A separation radio information transmission system comprised of a host and a remote terminal; the host being integrated with a microprocessor, a high capacity storage medium, a memory, a wireless transmission modulus and a power supply modulus; and the remote terminal being integrated with a microprocessor, a photo-sensitive member, a memory, a wireless transmission modulus, a power supply modulus and related operation keys; both of the host and the remote terminal being capable of standing alone control and operation as a radio information transmission device; both being coupled to each other by means of the wireless transmission modulus; and the high capacity storage medium in the host providing the space for the storage of image/video data retrieved by the remote terminal.

9. The separation radio information transmission system of claim 8, wherein, the host is further integrated with a monitor.

10. The separation radio information transmission system of claim 8, wherein, the remote terminal is further integrated with a monitor.

11. The separation radio information transmission system of claim 8, wherein, a data transmission port is provided to the host and the remote terminal.

12. The separation radio information transmission system of claim 8, wherein, the wireless transmission modulus relates to a Bluetooth wireless transmission modulus.

13. The separation radio information transmission system of claim 8, wherein, the power supply modulus operates on battery power.

14. The separation radio information transmission system of claim 8, wherein, the host relates to a portable electronic device including a notebook computer, a tablet PC or a PDA.

15. The separation radio information transmission system of claim 8, wherein, the photosensitive member in the remote terminal relates to a CMOS photosensitive member.

16. The separation radio information transmission system of claim 8, wherein, the photosensitive member in the remote terminal relates to a CCD photosensitive member.

17. A separation radio information transmission system comprised of a host and a remote terminal; the host being integrated with a microprocessor, a high capacity storage medium, a memory, a wireless transmission modulus and a power supply modulus; and the remote terminal being integrated with a microprocessor, a memory, a wireless transmission modulus, an output port, a power supply modulus and related operation keys; both of the host and the remote terminal being capable of standing alone control and operation as a radio information transmission device; both being coupled to each other by means of the wireless transmission modulus; and the remote terminal being capable of unloading data from the host and/or registering data in the host.
